(19) United States
(12) Patent Application Publication
(10) Pub. No.: US 2015/0180794 A1
(43) Pub. Date: Jun. 25, 2015

(54) SYSTEMS AND METHODS FOR CONTROLLING MODEMS IN A COMPUTING DEVICE

(71) Applicant: QUALCOMM Incorporated, San Diego, CA (US)

(72) Inventors: Valeriya Perelman, Nesher (IL); Nela Gurevich, Yoqneam (IL); Bojin Liu, San Diego, CA (US); Rashid Ahmed Akbar Attar, San Diego, CA (US)

(73) Assignee: QUALCOMM Incorporated, San Diego, CA (US)

(21) Appl. No.: 14/136,242

(22) Filed: Dec. 20, 2013

(51) Int. Cl. H04L 12/865; H04W 28/02; H04L 12/859; H04L 12/863; H04L 12/927

(52) U.S. Cl. CPC H04L 47/6275; H04L 47/6255; H04L 47/803; H04L 47/2475; H04W 28/0215; H04W 88/02

(57) ABSTRACT

Systems and methods for controlling a modem in a computing device are disclosed. In one embodiment, a traffic scheduler is logically positioned between the applications and the net driver of the computing device. The traffic scheduler receives all the packets from the applications and prioritizes the packets in a smart queue. Based on the available uplink bandwidth and/or the queue at the modem, the traffic scheduler passes packets from the smart queue to the net driver to be passed to the modem. In addition to having the benefit of having the higher priority packets be passed before the lower priority packets, the traffic scheduler has the added advantage of allowing the deletion of packets that are no longer needed (e.g., packets generated by a program that the user has closed).

### BACKGROUND

I. Field of the Disclosure

The technology of the disclosure relates generally to controlling a modem in a computing device.

II. Background

Mobile communication devices have become common in current society. The prevalence of these mobile devices is driven in part by the many functions that are now enabled on such devices. Many of these functions rely on the ability to communicate with websites on the Internet or other sources removed from the mobile device. The proliferation of functions and applications that rely on communication with remote sources is generally handled by packets that pass through the wireless transceiver (e.g., a cellular modem) of the mobile device. Most such mobile devices rely on cellular protocols to handle the transmission and receipt of such packets.

While cellular networks have increasingly robust bandwidths available to users of such mobile devices, the mobile device may still suffer delays in transmission of packets in the cellular modem of the mobile device as the various functions all submit packets for transmission concurrently. Even if there is only one function sending packets such as a web browser, certain web pages may generate large numbers of packets at the cellular modem contributing to the congestion at the cellular modem.

In many instances, the priorities of the packets may be different. For example, some functions may be generating packets for transmission in the background, while other functions may be actively in use by the operator of the mobile device. For example, a weather program may be downloading tomorrow's weather in the background while the operator surfs the internet on a web browser. Likewise, even within a single web page, certain packet streams may be more important than others (e.g., a JavaScript may need to load before any text strings). In general, once the packet arrives at the modem, there is no mechanism for the modem to differentiate between the relative priorities of the packets. Even if priority information is received by the modem, the modem is not able to re-prioritize or remove packets dynamically. Consequently, performance is negatively affected.

### SUMMARY OF THE DISCLOSURE

Embodiments of the present disclosure relate to systems and methods for controlling a modem in a computing device. Exemplary embodiments of the present disclosure relate to a traffic scheduler logically positioned between the applications and the net driver of the computing device. The traffic scheduler receives all the packets from the applications and prioritizes the packets in a smart queue. Based on the available uplink bandwidth and/or the queue at the modem, the traffic scheduler passes packets from the smart queue to the net driver to be passed to the modem. In addition to having the benefit of having the higher priority packets be passed before lower priority packets, the traffic scheduler has the added advantage of allowing the deletion of packets that are no longer needed (e.g., packets generated by a program that the user has closed).

In this regard in one embodiment, a non-transitory computer readable medium comprising software with instructions is disclosed. The instructions may receive a plurality of packets from one or more applications operating on a mobile terminal. The instructions may determine a relative priority between the plurality of packets. The instructions may poll a modem of the mobile terminal about a queue length of packets present at the modem. The instructions may receive information from the modem related to the queue length of packets present at the modem. The instructions may hold lower priority packets in a queue while releasing higher priority packets to the modem based on the queue length of packets.

In another embodiment, a method of operating a mobile terminal is disclosed. The method comprises generating a plurality of packets in one or more applications operating on the mobile terminal. The method also comprises providing the plurality of packets to a traffic scheduler within the mobile terminal. The method also comprises determining a relative priority between the plurality of packets. The method also comprises polling a modem of the mobile terminal about a queue length of packets present at the modem. The method also comprises receiving information from the modem related to the queue length of packets present at the modem. The method also comprises holding lower priority packets in a queue while releasing higher priority packets to the modem based on the queue length of packets.

In another embodiment, a mobile terminal is disclosed. The mobile terminal comprises a user interface. The mobile terminal also comprises a modem configured to couple the mobile terminal to a network. The mobile terminal also comprises a control system operatively coupled to the user interface and the modem. The control system is configured to receive a plurality of packets from one or more applications. The control system is also configured to determine a relative priority between the plurality of packets. The control system is also configured to poll the modem about a queue length of packets present at the modem. The control system is also configured to receive information from the modem related to the queue length of packets present at the modem. The control system is also configured to hold lower priority packets in a queue while releasing higher priority packets to the modem based on the queue length of packets.

In another embodiment, a computing device is disclosed. The computing device comprises a user interface. The computing device also comprises a modem configured to couple the computing device to a network. The computing device also comprises a control system operatively coupled to the user interface and the modem. The control system is configured to receive a plurality of packets from one or more applications. The control system is also configured to determine a relative priority between the plurality of packets. The control system is also configured to poll the modem about a queue length of packets present at the modem. The control system is also configured to receive information from the modem related to the queue length of packets present at the modem. The control system is also configured to hold lower priority packets in a queue while releasing higher priority packets to the modem based on the queue length of packets.

### BRIEF DESCRIPTION OF THE FIGURES

FIG. 1 is a simplified view of a computing device communicating in a network that may use a modem to pass packets;

FIG. 2 is a perspective view of a mobile terminal communicating in a cellular network that may use a modem to pass packets;

FIG. 3 is a block diagram of components of the mobile terminal of FIG. 2;

FIG. 4 is a block diagram of components that implement exemplary packet control embodiments for a modem of the present disclosure;

FIG. 5 is a flow chart of an exemplary embodiment of a method for controlling a modem according to the present disclosure;

FIG. 6 is a data flow diagram illustrating an exemplary embodiment of packet control for a modem according to the present disclosure; and

FIG. 7 is a data flow diagram illustrating an exemplary embodiment of packet control for a modem according to the present disclosure.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments of the present disclosure relate to systems and methods for controlling a modem in a computing device. Exemplary embodiments of the present disclosure relate to a traffic scheduler logically positioned between the applications and the net driver of the computing device. The traffic scheduler receives all the packets from the applications and prioritizes the packets in a smart queue. Based on the available uplink bandwidth and/or the queue at the modem, the traffic scheduler passes packets from the smart queue to the net driver to be passed to the modem. In addition to having the benefit of having the higher priority packets be passed before lower priority packets, the traffic scheduler has the added advantage of allowing the deletion of packets that are no longer needed (e.g., packets generated by a program that the user has closed).

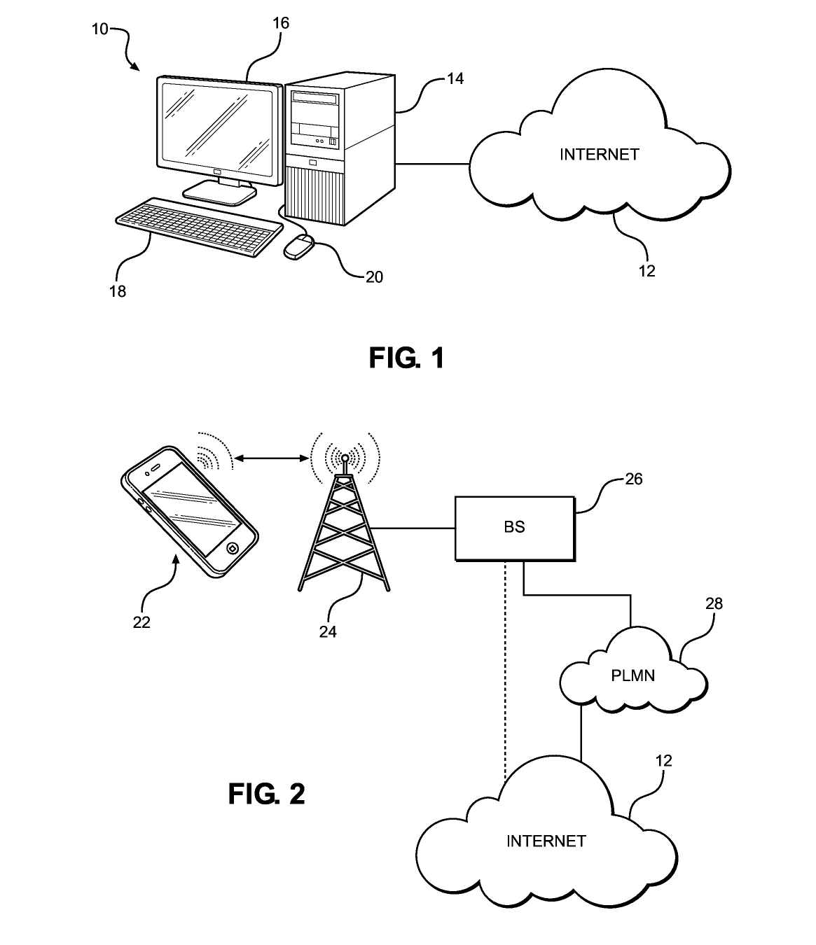

While an exemplary embodiment of the present disclosure contemplates use in a mobile terminal such as a cellular phone using a cellular modem, the present disclosure is not so limited. In this regard, FIG. 1 illustrates a computing device 10 coupled to a network 12, which, in an exemplary embodiment, is the internet. The computing device may include a housing 14 with a central processing unit (CPU, not illustrated) therein. A user may interact with the computing device 10 through a user interface formed from input/output elements such as a monitor (sometimes referred to as a display) 16, a keyboard 18, and/or a mouse 20. In some embodiments, the monitor 16 may be incorporated into the housing 14. While a keyboard 18 and mouse 20 are illustrated, the monitor 16 may be a touchscreen display, which may supplement or replace the keyboard 18 and mouse 20. Other input/output devices may also be present as is well understood in conjunction with desktop or laptop style computing devices. While not illustrated in FIG. 1, the housing 14 may also include a modem therein. The modem may be positioned on a network interface card (NIC) as is well understood. Likewise, a router and/or an additional modem may be external to the housing 14. For example, the computing device 10 may couple to the network 12 through a router and a cable modem as is well understood. However, even where such external routers and modems are present, the computing device 10 is likely to have an internal modem to effectuate communication with such external routers and modems.

In addition to computing devices 10, the exemplary embodiments of the present disclosure may also be implemented on mobile computing devices. In this regard, an exemplary embodiment of a mobile terminal 22 is illustrated in FIG. 2. The mobile terminal 22 may be a smart phone such as a SAMSUNG GALAXY™ or APPLE iPHONE®. Instead of a smart phone, the mobile terminal 22 may be a cellular telephone, a tablet, a laptop, or other mobile computing device. The mobile terminal 22 may communicate with a remote antenna 24 associated with a base station (BS) 26. The BS 26 may communicate with the public land mobile network (PLMN) 28, the public switched telephone network (PSTN, not shown), or a network 12 (e.g., the internet). It is also possible that the PLMN 28 communicates with the internet (e.g., network 12) either directly or through an intervening network. It should be appreciated that most contemporary mobile terminals 22 allow for various types of communication with elements of network 12. For example, streaming audio, streaming video, and/or web browsing are all common functions on most contemporary mobile terminals 22. Such functions are enabled through applications stored in memory of the mobile terminal 22 and using the wireless transceiver of the mobile terminal 22.

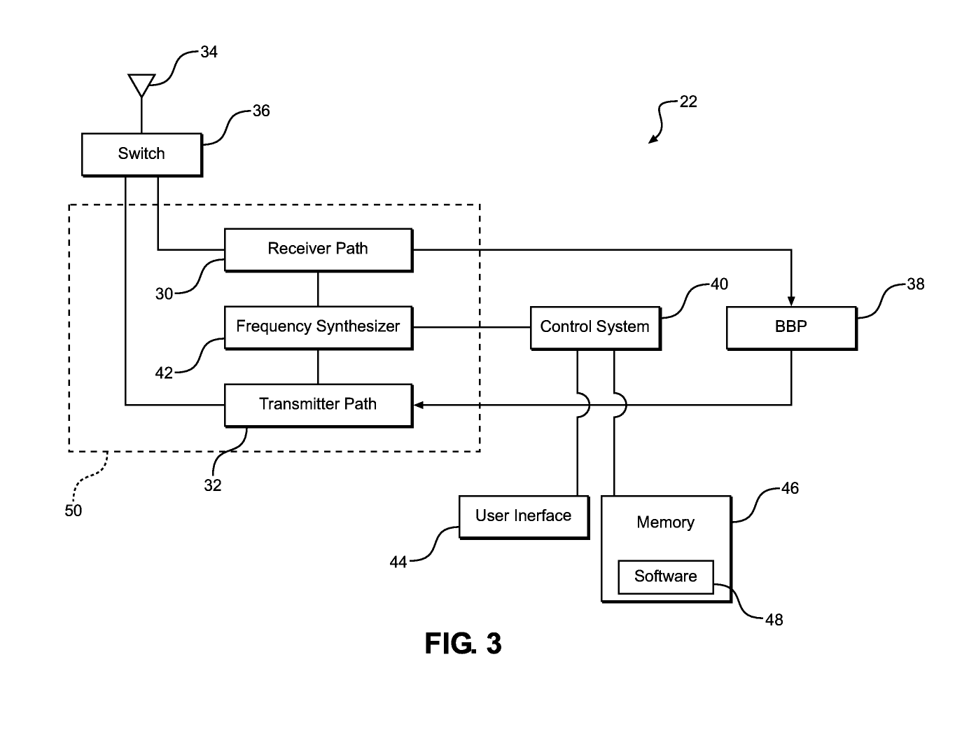

A more detailed depiction of the components of the mobile terminal 22 is provided with reference to FIG. 3. In this regard, a block diagram of some of the elements of the mobile terminal 22 is illustrated. The mobile terminal 22 may include a receiver path 30, a transmitter path 32, an antenna 34, a switch 36, a baseband processor (BBP) 38, a control system 40, a frequency synthesizer 42, a user interface 44 and memory 46 with software 48 stored therein.

The receiver path 30 receives information bearing RF signals from one or more remote transmitters provided by BS 26. A low noise amplifier (not shown) amplifies the signal. A filter (not shown) minimizes broadband interference in the received signal, while down conversion and digitization circuitry (not shown) down converts the filtered, received signal to an intermediate or baseband frequency signal, which is then digitized into one or more digital streams. The receiver path 30 typically uses one or more mixing frequencies generated by the frequency synthesizer 42. The BBP 38 processes the digitized received signal to extract the information or data bits conveyed in the signal. As such, the BBP 38 is typically implemented in one or more digital signal processors (DSPs).

With continued reference to FIG. 3, on the transmit side, the BBP 38 receives digitized data, which may represent voice, data, or control information, from the control system 40, which it encodes for transmission. The encoded data is output to the transmitter path 32, where it is used by a modulator (not shown) to modulate a carrier signal at a desired transmit frequency. An RF power amplifier (not shown) amplifies the modulated carrier signal to a level appropriate for transmission, and delivers the amplified and modulated carrier signal to the antenna 34 through the switch 36. Collectively, the receiver path 30, transmitter path 32 and frequency synthesizer 42 may be considered a wireless modem 50.

With continued reference to FIG. 3, a user may interact with the mobile terminal 22 via the user interface 44, such as a microphone, a speaker, a keypad, and a display. Audio information encoded in the received signal is recovered by the BBP 38, and converted into an analog signal suitable for driving the speaker. The keypad and display enable the user to interact with the mobile terminal 22. For example, the keypad and display may enable the user to input numbers to be dialed, access address book information, or the like, as well as monitor call progress information. The memory 46 may have software 48 therein as noted above which may effectuate exemplary embodiments of the present disclosure.

While not illustrated, it should be appreciated that a less mobile computing device 10 may have similar elements, but instead of a wireless modem 50, the NIC may have a wirebased interface to effectuate communication.

Regardless of whether the computing device is a mobile terminal 22 or a more stationary computing device 10, exemplary embodiments of the present disclosure allow the control system 40 to control congestion at the modem by polling the modem for uplink queue latency and selectively releasing packets to the modem based on the response from the modem. The particular packets that are released to the modem may be based on the priority of the packets, which improves performance. Further, packets that are no longer needed (e.g., corresponding to a web page that a user has closed, duplicative packets used for error correction, or the like) may be deleted once it is determined that they are no longer needed. For example, an application may lose its priority because it was switched to the background. Accordingly, the priority of these packets held in the queue may be dynamically re-designated as lower priority packets and repositioned within the queue. In an alternate embodiment, a web browser may request an image speculatively at a low priority, and then may upgrade the priority when it is realized that the image is used for styling of many nodes on a web page and the web browser needs the image. Because the packets are held at the applications layer, dynamic re-prioritization/cancelation of the packets before being sent to the modem is possible. In an exemplary embodiment, the software 48 may have a traffic scheduler that includes a queue of packets. Based on the response to the polling, a decision engine within the traffic scheduler releases packets to the modem based on packet priority. By keeping the packets at the application layer, congestion at the modem is reduced. Likewise, by providing a software solution at the application layer, the change is effectively transparent to the modem, and thus, the modem does not have to undergo a lengthy, costly, and difficult reprogramming process with associated debugging.

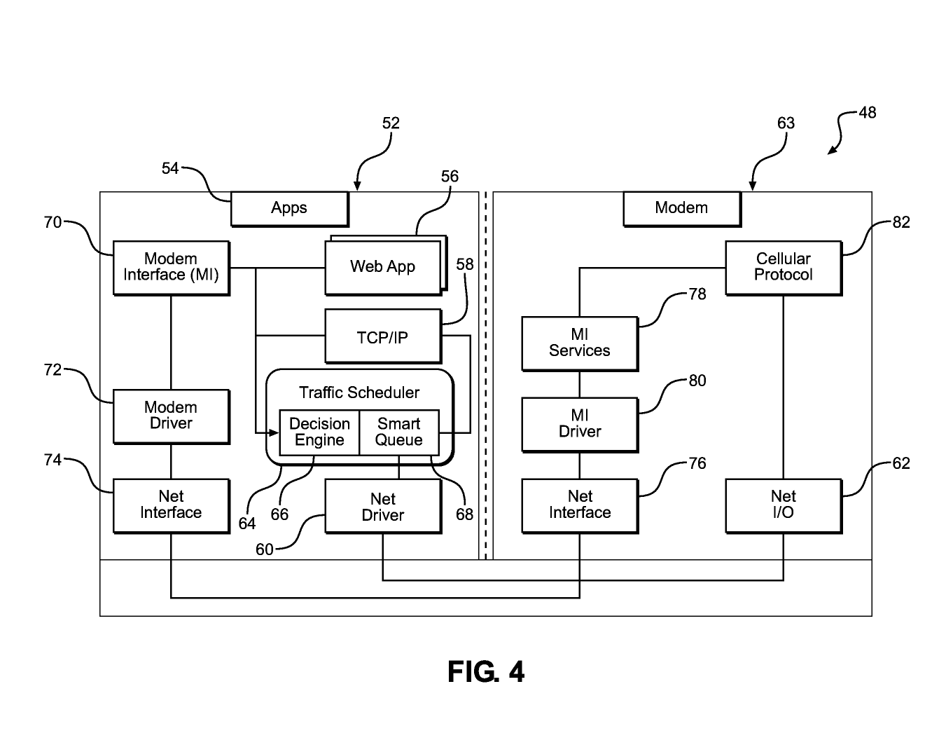

In this regard, a block diagram of exemplary embodiments of software 48 for controlling the modem is illustrated in FIG. 4. At the application layer 52, the applications 54 may include a web application 56—such as a web browser—that uses a transmission control protocol (TCP)/internet protocol (IP) 58 to assemble packets. While TCP/IP 58 is illustrated, it should be appreciated that other packet based protocols such as user datagram protocol (UDP) or the like may also be used. In conventional systems, the TCP/IP 58 passes packets assembled from the data and data requests of the web application 56 to the net driver 60 and they are immediately passed to the net input/output 62 of the modem 63 (e.g., wireless modem 50). However, in exemplary embodiments of the present disclosure, a traffic scheduler 64 is logically placed between the TCP/IP 58 and the net driver 60. The traffic scheduler 64 includes a decision engine 66 and a smart queue 68. The control system (e.g., control system 40) uses the modem interface 70 to query the modem 63 about the status of the modem 63 and in particular the packet queue in the modem 63. This information about the packet queue is passed to the decision engine 66 of the traffic scheduler 64. As is well understood, the modem interface 70 may use a modem driver module 72 and pass such queue length query through a net interface 74.

With continued reference to FIG. 4, the modem 63 receives the queue length query at the net interface 76. The query is passed to a modem interface service module 78 through a modem interface driver 80. The modem interface services module 78 provides an answer back through the net interface 76 as is well understood. The modem interface services module 78 may consult memory in the modem 63 to ascertain the packet queue length. Packets accumulate in the queue after having been passed to the modem 63 from the net driver 60 and received at the net input/output 62. Packets are converted into a format suitable for transmission over the network by the cellular protocol module 82. For example, the packets may be processed by the BBP 38, and then up converted in the transmitter path 32 (FIG. 3) as is well understood.

With continued reference to FIG. 4, as packets are generated by the TCP/IP 58, they are queued into the smart queue 68. The web application 56 may append a priority to the packet indicating how important the packet is. Alternatively, the packet importance may be inferred from the application that sent the packet or the resource type of the packet (e.g., JavaScript, cascading style sheets, image, audio, text, or the like). The decision engine 66 uses the information received about the packet queue length to evaluate or infer available uplink bandwidth. Based on the available uplink bandwidth and congestion at the modem, the decision engine 66 selectively releases higher priority packets to the net driver 60 to be passed to the modem 63. Additionally, if the web application 56 informs the decision engine 66 that a packet is no longer needed, the decision engine 66 may delete the unneeded packet. For example, if a user closes a web page, packets associated with that closed page may be deleted.

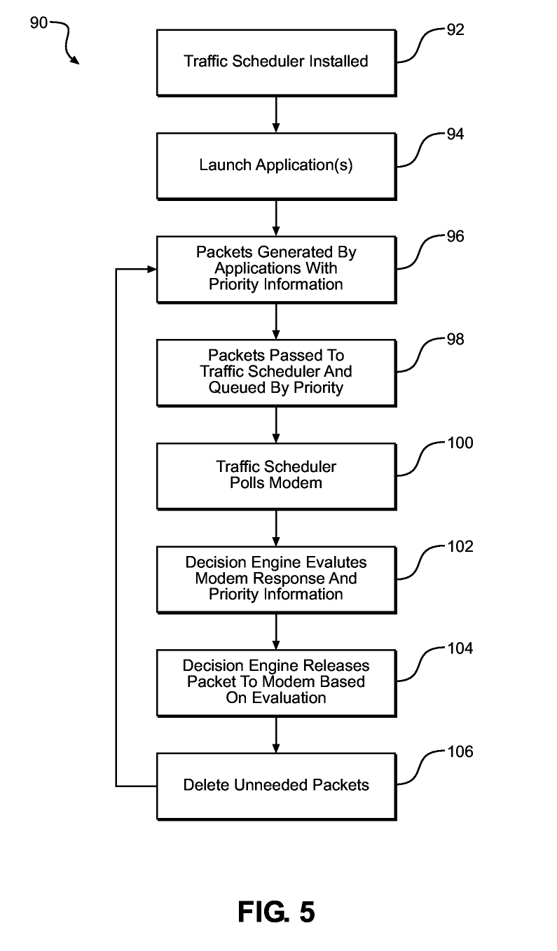

A flow chart of an exemplary process 90 for controlling a modem in a computing device is provided with reference to FIG. 5. Process 90 begins with installation of the traffic scheduler 64 in memory 40 (block 92). The user launches one or more applications on the computing device 10, 22 (block 94) including applications which generate packets. The application(s) generates packets with priority information associated with the packets (block 96). The packets and the priority information are passed to the traffic scheduler 64, which queues the packets by priority information (block 98). In an exemplary embodiment, the priority information is designated by a flag or other metadata. In another exemplary embodiment, the priority information is inherent in the resource type of the packet. For example, JavaScript packets may be higher priority than text packets or cascading style sheets may be higher priority than images. In another exemplary embodiment, the priority information is based on the application that generated the packet. For example, packets generated by a YOUTUBE™ application may always be given higher priority than packets generated by a search engine program such as GOOGLE™. As additional packets are received, the queue may be rearranged so that incoming packets with high priority are placed above older packets with lower priority. Additionally, aging may be used to increment a priority value for packets if desired.

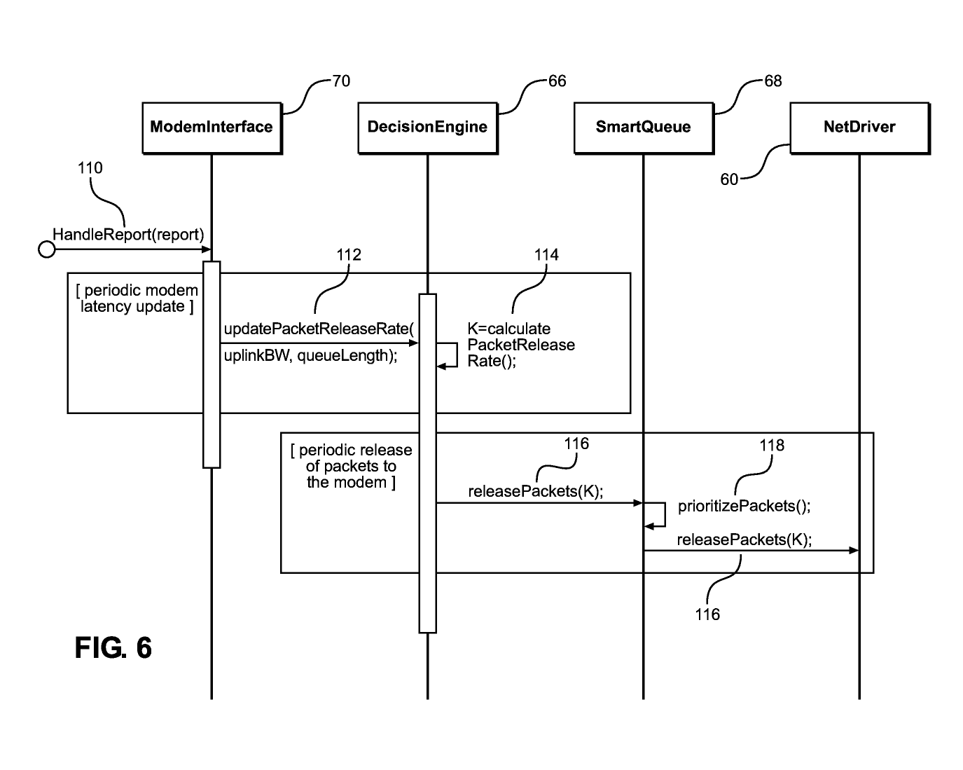

With continued reference to FIG. 5, process 90 continues with the traffic scheduler 64 polling the modem 63 (block 100). The polling may be done by the smart queue 68 using the net driver 60 to poll the modem interface services 78. The modem 63 responds with information relating to the available uplink bandwidth as well as the queue length of packets at the modem such as through a HandleReport(report) signal (see FIG. 6). The queue length may be expressed as either a number of packets or an amount of data contained in the packets.

With continued reference to FIG. 5, process 90 continues with the decision engine 66 evaluating the response from the modem 63 (i.e., the queue length) and the priority information of the packets in the smart queue 68 (block 102). If the queue length at the modem 63 is below a predefined threshold, packets may be released from the smart queue 68 (block 104). Applications may inform the traffic scheduler 64 that packets are no longer needed (e.g., if an application has been closed since the packet associated with that application was generated). The traffic scheduler 64 may then delete the unneeded packet from the smart queue 68 (block 106). The process continues as indicated as the applications continue to generate new packets (block 96).

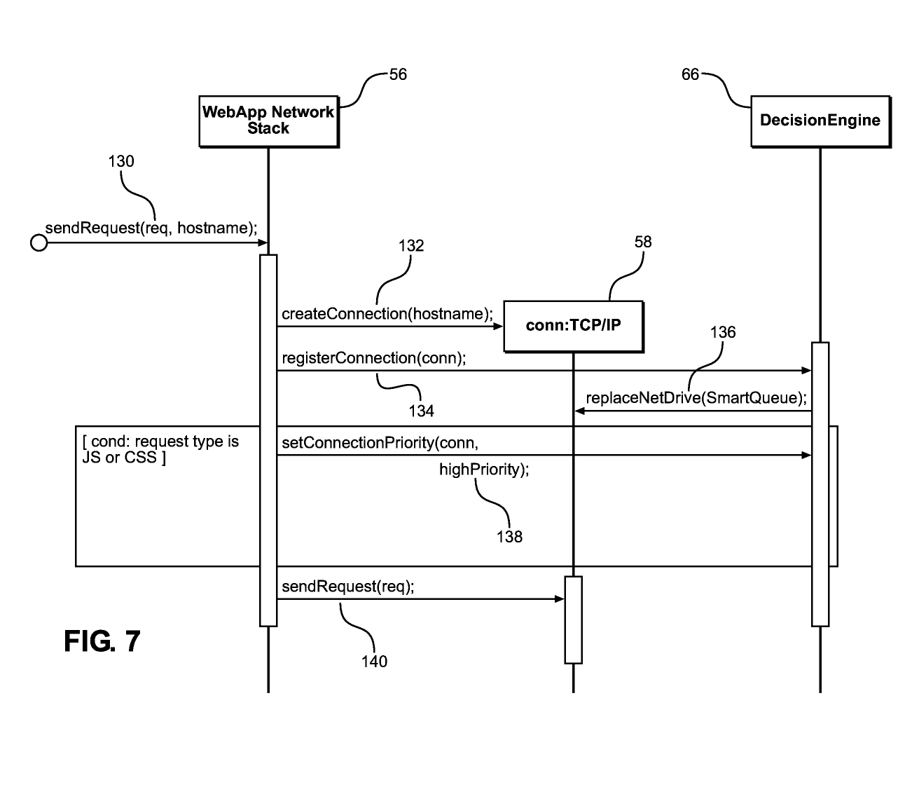

While the process 90 provides an overview of the steps taken by the traffic scheduler 64 in the controlling of the modem 63, FIGS. 6 and 7 provide a more detailed description of exemplary data flows that may be used. In this regard, the modem interface 70 receives the HandleReport(report) signal 110 that contains information about the queue length and latency update from the modem 63. The modem interface 70 then sends an updatePacketReleaseRate(uplinkBW, queueLength) signal 112 to the decision engine 66. The uplinkBW and queueLength variables have been extracted from the HandleReport(report) signal 110. The decision engine 66 calculates a release rate K 114, which is passed to the smart queue 68 through the releasePackets(K) signal 116. The smart queue 68 has executed a prioritizePackets command 118 to arrange the packets by priority information. On arrival of the releasePackets (K) signal 116, the smart queue 68 releases K packets to the net driver 60 to be released to modem 63.

FIG. 7 illustrates the logical flows of the connection registration to the traffic scheduler 64. That is, the web applications 56 may register with the traffic scheduler 64 so that the web applications 56 know to send the packets to the traffic scheduler 64 instead of straight to the net driver 60 and modem 63. In this regard, the web application 56 receives a sendRequest (req, hostname) signal 130. This signal 130 may include the uniform resource locator (URL) of a desired web page or the like. The web application 56 sends a createConnection (hostname) signal 132 to the TCP/IP module 58. Additionally, the web application 56 sends a registerConnection(conn) signal 134 to the decision engine 66. The decision engine 66 sends a replaceNetDriver(smartqueue) signal 136 to the TCP/IP module 58. The replaceNetDriver(smartqueue) signal 136 instructs the TCP/IP module 58 to send all packets to the traffic scheduler 64 for inclusion in the smart queue 68. If the req variable in the sendRequest signal 130 is a JavaScript (JS) or cascading style sheet (CSS), the web application sends a setConnectionPriority (conn, highPriority) signal 138 so that the decision engine 66 evaluates such requests as having a higher priority than other packets. After registration, the sendRequest(req) signal 140 is passed from the web application 56 to the TCP/IP module 58.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A non-transitory computer readable medium comprising software with instructions to:
receive a plurality of packets from one or more applications operating on a mobile terminal;
determine a relative priority between the plurality of packets;
poll a modem of the mobile terminal about a queue length of packets present at the modem;
receive information from the modem related to the queue length of packets present at the modem; and
hold lower priority packets in a queue while releasing higher priority packets to the modem based on the queue length of packets.

2. The computer readable medium of claim 1, wherein the instructions are further configured to prioritize packets based on application source with the one or more applications.

3. The computer readable medium of claim 1, wherein the instructions are further configured to prioritize based on resource type.

4. The computer readable medium of claim 3, wherein the resource type is selected from the group consisting of image, JavaScript (JS), cascading style sheets (css), and text.

5. The computer readable medium of claim 1, wherein the instructions are further configured to receive information relating to an uplink bandwidth available to the modem.

6. The computer readable medium of claim 5, wherein the instructions are further configured to evaluate the uplink bandwidth available to the modem and base holding of the lower priority packets and release of the higher priority packets at least in part on the available uplink bandwidth.

7. The computer readable medium of claim 1, wherein the instructions to hold the lower priority packets in a queue while releasing the higher priority packets to the modem based on the queue length of packets comprise instructions to calculate a packet release rate.

8. The computer readable medium of claim 1, wherein the instructions are logically positioned between a protocol module and a net driver module.

9. The computer readable medium of claim 1, wherein the instructions are further to determine that a packet in the plurality of packets is no longer needed and delete the packet that is no longer needed.

10. A method of operating a mobile terminal comprising:
generating a plurality of packets in one or more applications operating on the mobile terminal;
providing the plurality of packets to a traffic scheduler within the mobile terminal;
determining a relative priority between the plurality of packets;
polling a modem of the mobile terminal about a queue length of packets present at the modem;
receiving information from the modem related to the queue length of packets present at the modem; and
holding lower priority packets in a queue while releasing higher priority packets to the modem based on the queue length of packets.

11. The method of claim 10, further comprising prioritizing packets based on application source with the one or more applications.

12. The method of claim 10, further comprising prioritizing packets based on resource type.

13. The method of claim 12, wherein the resource type is selected from the group consisting of image, JavaScript (JS), cascading style sheets (css), and text.

14. The method of claim 10, further comprising receiving information relating to an uplink bandwidth available to the modem.

15. The method of claim 14, further comprising evaluating the uplink bandwidth available to the modem and base holding of the lower priority packets and release of the higher priority packets at least in part on the available uplink bandwidth.

16. The method of claim 10, wherein holding the lower priority packets in a queue while releasing the higher priority packets to the modem based on the queue length of packets comprises calculating a packet release rate.

17. The method of claim 10, further comprising determining that a packet in the plurality of packets is no longer needed and deleting the packet that is not needed.

18. A mobile terminal comprising:
a user interface;
a modem configured to couple the mobile terminal to a network; and
a control system operatively coupled to the user interface and the modem, the control system configured to:
receive a plurality of packets from one or more applications;
determine a relative priority between the plurality of packets;
poll the modem about a queue length of packets present at the modem;
receive information from the modem related to the queue length of packets present at the modem; and
hold lower priority packets in a queue while releasing higher priority packets to the modem based on the queue length of packets.

19. The mobile terminal of claim 18, wherein the mobile terminal comprises a cellular telephone.

20. The mobile terminal of claim 18, wherein the mobile terminal comprises a smart phone.

21. The mobile terminal of claim 18, wherein modem comprises a cellular modem.

22. A computing device comprising:
a user interface;
a modem configured to couple the computing device to a network; and
a control system operatively coupled to the user interface and the modem, the control system configured to:
receive a plurality of packets from one or more applications;
determine a relative priority between the plurality of packets;
poll the modem about a queue length of packets present at the modem;
receive information from the modem related to the queue length of packets present at the modem; and
hold lower priority packets in a queue while releasing higher priority packets to the modem based on the queue length of packets.
